(19) United States
(12) Patent Application Publication
(10) Pub. No.: US 2014/0102407 A1
(43) Pub. Date: Apr. 17, 2014

(54) INTEGRATED FUEL INJECTOR IGNITERS CONFIGURED TO INJECT MULTIPLE FUELS AND/OR COOLANTS AND ASSOCIATED METHODS OF USE AND MANUFACTURE

(71) Applicant: McAlister Technologies, LLC, (US)

(72) Inventors: Roy Edward McAlister, Phoenix, AZ (US); Melvin James Larsen, Chandler, AZ (US)

(73) Assignee: McAlister Technologies, LLC, Phoenix, AZ (US)

(21) Appl. No.: 13/864,192

(22) Filed: Apr. 16, 2013

Related U.S. Application Data
(63) Continuation of application No. 12/961,461, filed on Dec. 6, 2010, now abandoned.

(51) Int. Cl. F02B 17/00

(52) U.S. Cl. CPC F02B 17/005
USPC 123/304

(57) ABSTRACT

Embodiments of injectors configured for adaptively injecting multiple different fuels and coolants into a combustion chamber, and for igniting the different fuels, are disclosed herein. An injector according to one embodiment includes a body having a first end portion and a second end portion. The injector further includes a first flow channel extending through the body, and a second flow channel extending through the body that is separate from the first flow channel and electrically isolated from the first flow channel. The first flow channel is configured to receive a first fuel, and the second flow channel is configured to receive at least one of a second fuel and a coolant. The injector further comprises a valve carried by the body that is movable between a closed position and an open position to introduce at least one of the second fuel and the coolant into a combustion chamber.

### CROSS REFERENCE TO RELATED APPLICATIONS

This application is a continuation of U.S. application Ser. No. 12/961,461, filed Dec. 6, 2010 and titled “INTEGRATED FUEL INJECTOR IGNITERS CONFIGURED TO INJECT MULTIPLE FUELS AND/OR COOLANTS AND ASSOCIATED METHODS OF USE AND MANUFACTURE”.

### TECHNICAL FIELD

The following disclosure relates generally to integrated fuel injectors and igniters suitable for adaptively injecting multiple fuels and/or coolants into a combustion chamber.

### BACKGROUND

Fuel injection systems are typically used to inject a fuel spray into an inlet manifold or a combustion chamber of an engine. Fuel injection systems have become the primary fuel delivery system used in automotive engines, having almost completely replaced carburetors since the late 1980s. Conventional fuel injection systems are typically connected to a pressurized fuel supply, and fuel injectors used in these fuel injection systems generally inject or otherwise release the pressurized fuel into the combustion chamber at a specific time relative to the power stroke of the engine. In many engines, and particularly in large engines, the size of the bore or port through which the fuel injector enters the combustion chamber is small. This small port accordingly limits the size of the components that can be used to actuate or otherwise inject fuel from the injector. Moreover, such engines also generally have crowded intake and exhaust valve train mechanisms, further restricting the space available for components of these fuel injection systems.

### BRIEF DESCRIPTION OF THE DRAWINGS

FIG. 1A is a cross-sectional side view of an integrated injector igniter configured in accordance with an embodiment of the disclosure.

FIGS. 1B-1D are a series of cross-sectional end views of the injector of FIG. 1A taken substantially along lines 1B-1B in FIG. 1A.

FIGS. 2A-2D are a series of cross-sectional side views of nozzle portions of injectors configured in accordance with embodiments of the disclosure.

FIG. 3A is a cross-sectional side view of a valve distribution subassembly, and FIG. 3B is a plan partial view of a distribution assembly.

### DETAILED DESCRIPTION

The present application incorporates by reference in its entirety the subject matter of U.S. patent application Ser. No. 12/961,453, filed Dec. 6, 2010 and titled “INTEGRATED FUEL INJECTOR IGNITERS HAVING FORCE GENERATING ASSEMBLIES FOR INJECTING AND IGNITING FUEL AND ASSOCIATED METHODS OF USE AND MANUFACTURE”.

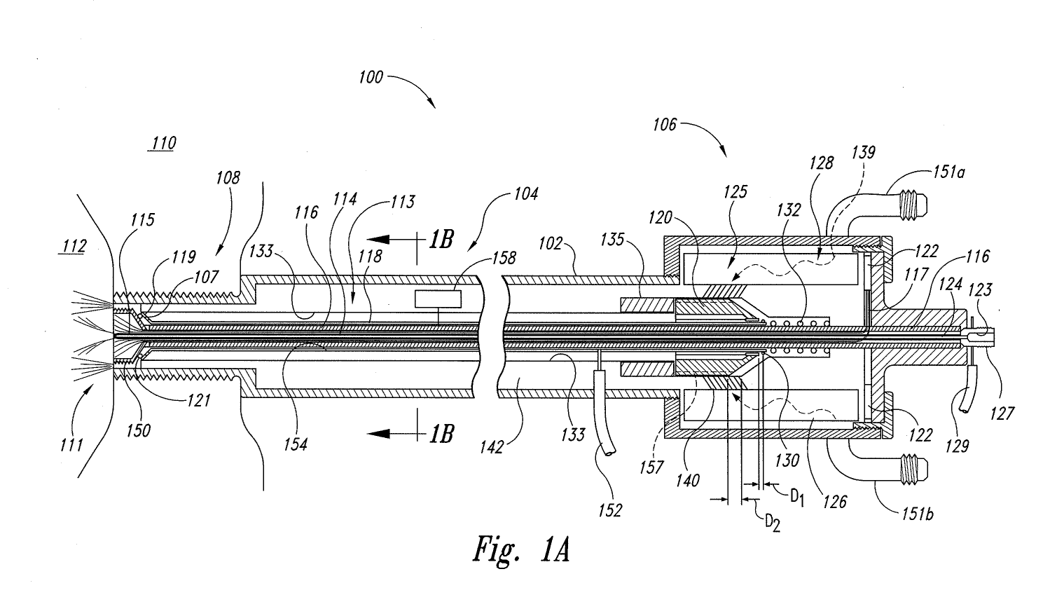

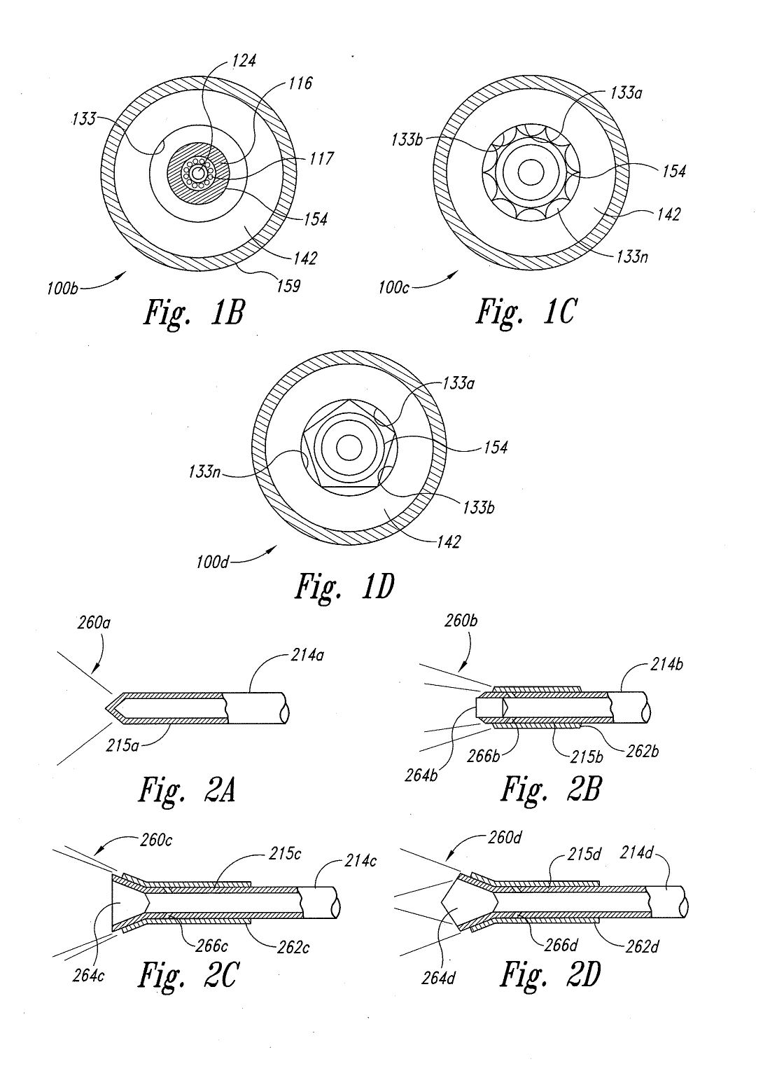

The present disclosure describes integrated fuel injection and ignition devices for use with internal combustion engines, as well as associated systems, assemblies, components, and methods regarding the same. For example, several of the embodiments described below are directed generally to adaptable fuel injectors/igniters that can inject two or more fuels, coolants, or combinations of fuels and coolants into a combustion chamber during operation. As used herein, the term coolant can include any fluid (e.g., gas or liquid) that produces cooling. In one embodiment, for example, a coolant can include non-combusting fluid. In other embodiments, however, a coolant can include a fuel that ignites and/or combusts at a lower temperature than another fuel. In certain other embodiments a fluid (e.g., a coolant) provides cooling of substances such as air or components of a combustion chamber. Certain details are set forth in the following description and in FIGS. 1A-3D to provide a thorough understanding of various embodiments of the disclosure. However, other details describing well-known structures and systems often associated with internal combustion engines, injectors, igniters, and/or other aspects of combustion systems are not set forth below to avoid unnecessarily obscuring the description of various embodiments of the disclosure. Thus, it will be appreciated that several of the details set forth below are provided to describe the following embodiments in a manner sufficient to enable a person skilled in the relevant art to make and use the disclosed embodiments. Several of the details and advantages described below, however, may not be necessary to practice certain embodiments of the disclosure.

Many of the details, dimensions, angles, shapes, and other features shown in the Figures are merely illustrative of particular embodiments of the disclosure. Accordingly, other embodiments can have other details, dimensions, angles, and features without departing from the spirit or scope of the present disclosure. In addition, those of ordinary skill in the art will appreciate that further embodiments of the disclosure can be practiced without several of the details described below.

Reference throughout this specification to “one embodiment” or “an embodiment” means that a particular feature, structure, or characteristic described in connection with the embodiment is included in at least one embodiment of the present disclosure. Thus, the occurrences of the phrases “in one embodiment” or “in an embodiment” in various places throughout this specification are not necessarily all referring to the same embodiment. Furthermore, the particular features, structures, or characteristics described with reference to a particular embodiment may be combined in any suitable manner in one or more other embodiments. Moreover, the headings provided herein are for convenience only and do not interpret the scope or meaning of the claimed disclosure.

FIG. 1A is a cross-sectional side view of an integrated injector/igniter 100 (“injector 100”) configured in accordance with an embodiment of the disclosure. The injector 100 includes a body 102 having a middle portion 104 extending between a first end portion or base portion 106 and a second end portion of a nozzle portion 108. The nozzle portion 108 is configured to at least partially extend through an engine head 110 to inject and ignite fuel at or near an interface 111 of a combustion chamber 112. As described in detail below, the injector 100 is particularly suited to provide adaptive and rapid actuation of two or more fuels, coolants, or combinations of fuels and coolants.

In the embodiment shown in FIG. 1A, the injector 100 includes a core assembly 113 extending from the base portion 106 to the nozzle portion 108. The injector 100 also includes a body insulator 142 coaxially disposed over at least a portion of the core assembly 113. The core assembly 113 includes an ignition conduit, rod, or conductor 114, an ignition insulator 116, and a valve 118. The ignition insulator 116 is coaxially disposed over at least a portion of the ignition conductor 114 and extends from the base portion 106 to the nozzle portion 108. As described in detail below, the valve 118 is coaxially disposed over at least a portion of the ignition insulator and moves longitudinally through the body 102. For example, the valve 118 is an inwardly opening valve (e.g., opening in a direction away from the combustion chamber) and is movable relative to the core insulator 114 to selectively introduce fuel from the nozzle portion 108 into the combustion chamber 112. More specifically, the valve 118 is configured to slide or otherwise move relative to the core insulator 116 in directions that are generally parallel to a longitudinal axis of the injector 100. The valve 118 includes a first end portion in the base portion 106 that engages a valve operator assembly 125. The valve 118 also includes a second or sealing end portion 119 that engages or otherwise contacts a valve seal 121 in the nozzle portion 108 carried by the second ignition feature 150. The sealing end portion 119 also includes an exit opening 107 positioned radially inwardly from the valve seal 121. As described in detail below, the exit opening 107 allows a fuel or coolant to pass from a second flow passage 133 to be adjacent to the valve seal 121, and when the sealing end portion 119 spaces apart from the valve seal 121, the fuel or coolant can exit the nozzle portion 108. The sealing end portion 119 and/or the valve seal 121 can include one or more elastomeric portions. As described in detail below, the valve operator assembly 125 actuates the valve 118 relative to the ignition insulator 116 between an open position and a closed position (as shown in FIG. 1A). In the open position, the sealing end portion 119 of the valve 118 is spaced apart from the valve seal 121 to allow fuel or coolant to flow past the valve seal 121 and out of the nozzle portion 108 to produce distribution pattern 160 as shown in FIG. 1A.

In certain embodiments, the valve 118 can be made from reinforced structural composites as disclosed in U.S. patent application Ser. No. 12/857,461, filed Aug. 16, 2010, and titled “INTERNALLY REINFORCED STRUCTURAL COMPOSITES AND ASSOCIATED METHODS OF MANUFACTURING,” which is incorporated herein by reference in its entirety. For example the valve 118 can be made from relatively low density spaced graphite or graphene structures that provide the benefits of reducing inertia, achieving high strength and stiffness, and providing high fatigue endurance strength. More specifically, the valve 118 can be constructed from a light weight but strong graphite structural core that is reinforced by one or more carbon-carbon layers. The carbon-carbon layer(s) may be prepared from a suitable precursor application of carbon donor (e.g., petroleum pitch or a thermoplastic such as a polyolefin or PAN). The one or more carbon-carbon layers can further provide radio frequency shielding and protection. Additional protection may be established by plating the outer surface of the valve 118 with a suitable alloy, such as a nickel alloy that may be brazed to the valve 118 by a suitable braze alloy composition.

The ignition conductor 114 includes an end portion 115 proximate to the interface 111 of the combustion chamber 112 that includes one or more ignition features that are configured to generate an ignition event. The ignition conductor 114 also includes a first flow passage or channel 124 extending longitudinally through a central portion of the ignition conductor 114. The ignition conductor 114 is operably coupled to a first terminal 127 at the base portion 106. The first terminal 127 is configured to supply ignition energy (e.g., voltage), as well as a first fuel or first coolant, to the ignition conductor 114. More specifically, the first terminal 127 includes a first inlet passage 123 that is fluidly coupled to the first flow channel 124. The first terminal 127 is also configured to be coupled to a first fuel or coolant source, as described in detail below, to introduce the first fuel or coolant into the first flow channel 124 via the first inlet passage 123. The ignition conductor 114 therefore dispenses the first fuel or coolant into the combustion chamber 112 via the first flow channel 124. The first terminal 127 is also coupled to a first ignition energy source via a first ignition source conductor 129. The first ignition source conductor 129 accordingly provides first ignition energy to the ignition conductor 114 via the first terminal 127. The ignition conductor 114 can therefore ignite the first fuel at the nozzle portion 108 with the first ignition energy. In one embodiment, for example, the first terminal 127 can supply at least approximately 80 KV (DC or AC) to the ignition conductor 114. In other embodiments, however, the first terminal 127 can supply a greater or lesser voltage to the ignition conductor 114.

According to features of the illustrated embodiment, the first flow channel or passage 124 is electrically isolated or insulated from the second flow channel or passage 133. This electrical isolation allows for different ignition energies to be applied to the different fuels that flow through these passages. Moreover, and as described in detail below, the second flow passage 133 can include multiple discrete or fluidly separated channels or passages (see, e.g., FIGS. 1C and 1D). As such, different fuels and/or coolants can be separately transmitted through the second flow passage 133, in addition to different fuels and/or coolants that pass through the first flow channel or passage 124. More specifically, in one embodiment, a first fuel or first coolant can flow through the first flow passage 124, a second fuel or second coolant can flow through a first discrete channel in the second flow passage 133, and a third fuel or third coolant can flow through a second discrete channel in the second flow passage 133. In still further embodiments, more than three fuels or three coolants can flow through the various flow channels.

The injector 100 further includes an insulated second terminal 152 at the middle portion 104 or at the base portion 106. The second terminal 152 is electrically coupled to the second ignition feature 150 via a second ignition conductor 154. For example, the second ignition conductor 154 can be a conductive layer or coating disposed on the ignition insulator 116. The second ignition conductor 154 accordingly transmits the ignition energy (e.g., voltage) to the second ignition feature 150 at the nozzle portion 108. As shown in the illustrated embodiment, the second ignition feature 150 is coaxial and radially spaced apart from the end portion 115 of the ignition conductor 114. Moreover, in the illustrated embodiment, the second ignition features 150 can include a plurality of threads or acicular protrusions extending circumferentially around and spaced apart from the end portion 115 of the ignition conductor 114. In other embodiments, however, the second terminal 152 can be omitted and ignition energy can be supplied to the second ignition feature from a force generator assembly carried by the base portion 106.

The injector 100 further includes an energy storage provision such as capacitor 158 carried by the body 102. In the illustrated embodiment, the capacitor 158 is positioned in the body insulator 142 at the middle portion 104. In other embodiments, however, the capacitor 158 can be positioned at other locations, including for example, at or near the nozzle portion 108. The capacitor 158 is configured to provide ignition energy to ignite one or more fuels. For example, the capacitor 158 is coupled to the second ignition conductor 154. The capacitor can be charged by energy harvested from the combustion chamber 112 or from another suitable source. For example, the capacitor can be charged with and store ignition energy from photovoltaic, thermoelectric, acoustical, and/or pressure energy harvested from the combustion chamber 112.

According to features of the illustrated embodiment, the injector 100 is configured to provide different amounts or values of ignition energy as needed to ignite the corresponding fuels or coolants. For example, in one embodiment the first terminal 129 can provide a greater ignition energy than ignition energy from the second terminal 152, induced ignition energy in the force generator assembly 128, and/or stored ignition energy from the capacitor 158 for the purpose of initiating ignition of fuels that are relatively difficult to ignite. In other embodiments, however, these additional ignition energy sources can provide the greater ignition energy. Moreover, any of these ignition energy sources can be used for the purpose of sustaining the ignition event.

According to additional features of the illustrated embodiment, the injector 100 also includes a second flow passage or channel 133. In the illustrated embodiment, the second flow channel 133 extends longitudinally through the body 102 from the base portion 106 to the nozzle portion 108. More specifically, the second flow channel 133 extends coaxially with the stem portion of the valve 118 and is spaced radially apart from the stem portion of the valve 118. As explained in detail below, a second fuel or coolant can enter the second flow channel 133 from the base portion 106 of the injector 100 to pass to the combustion chamber 112. As also explained in detail below, the second flow channel 133 can include multiple discrete sub-channels or passages that are fluidly separated from one another, and that are coupled to corresponding individual fuel inlet passages 151 (identified individually as a first inlet passage 151a and a second inlet passage 151b). As such, multiple different second fuels and/or second coolants can travel through the corresponding sub-channels of the second flow passage 133.

The injector 100 can also include one or more sensors that are configured to detect properties or conditions in the combustion chamber 112. For example, in the illustrated embodiment injector 100 includes sensors or fiber optic cables 117 extending longitudinally through the body 102 from the base portion 106 to the nozzle portion 108. The fiber optic cables 117 can be coupled to or otherwise extend along with the ignition conductor 114. Moreover, the fiber optic cables 117 can be coupled to one or more controllers or processors 122 carried by the body 102. In the illustrated embodiment, the fiber optic cables 117 expand or otherwise fan radially outwardly at the nozzle portion 108 in the space between the ignition conductor 114 and the second ignition features 150. The expanded end portion of the fiber optic and/or other sensor cables 117 provides an increased area for the fiber optic cables 117 to gather information at the interface with the combustion chamber 112.

In addition to the valve operator assembly 125, the injector 100 also includes a force generator assembly 128 carried by the base portion 106. The valve operator assembly 125 is operably coupled to the valve 118 and configured to move the valve 118 between the open and closed positions in response to the force generator assembly 128. For example, the valve operator assembly 125 moves the valve 118 longitudinally in the injector 100 relative to the ignition insulator 116. The valve operator assembly 125 includes at least an actuator or driver 120 that is coupled to the valve 118. The force generator assembly 128 includes a force generator 126 (e.g., an electric, electromagnetic, magnetic, etc. force generator) that induces movement of the driver 120.

In certain embodiments, for example, the force generator 126 can be a solenoid that induces a magnetic field to move a ferromagnetic driver 120. In still further embodiments, the force generator assembly 128 can include two or more solenoid windings acting as a transformer for the purpose of inducing movement of the driver 120 and generating ignition energy. More specifically, a force generator assembly 128 having two or more force generators 126 can be configured to control fuel flow by opening any of the valve assemblies, and to produce of ionizing voltage upon completion of the valve opening function. To achieve both of these functions, in certain embodiments, for example, each force generator assembly 128 can be a solenoid winding including a first or primary winding and a secondary winding. The secondary winding can include more turns than the first winding. Each winding can also include one or more layers of insulation (e.g., varnish or other suitable insulators), however the secondary winding may include more insulating layers than the first winding. By configuring a force generator 126 as a transformer with a primary winding and a secondary winding of many more turns, the primary winding can carry high current upon application of voltage to produce pull or otherwise induce movement of the driver 120. Upon opening the relay to the primary winding, the driver 120 is released and a very high voltage will be produced by the secondary winding. The high voltage of the secondary winding can be applied to the plasma generation ignition event by providing the initial ionization, after which relatively lower voltage discharge of a capacitor that has been charged with any suitable source (including energy harvested from the combustion chamber 112 by photovoltaic, thermoelectric, and piezoelectric generators) and/or continue to supply ionizing current and thrust of fuel into the combustion chamber. Suitable force generating assemblies 128 are described in U.S. patent application Ser. No. 12/961,453, filed Dec. 6, 2010, titled “INTEGRATED FUEL INJECTOR IGNITERS HAVING FORCE GENERATING ASSEMBLIES FOR INJECTING AND IGNITING FUEL AND ASSOCIATED METHODS OF USE AND MANUFACTURE” and incorporated by reference in its entirety. In embodiments where the force generator assembly 128 includes two or more solenoid windings to induce movement of the driver 120 and generate ignition energy for the second ignition feature 150, the second terminal 152 can be omitted from the injector 100.

The force generator 128 can also be operably coupled to the processor or controller 122, which can in turn also be coupled to the one or more fiber optic cables 117 extending through the ignition conductor 114. As such, the controller 122 can selectively energize or otherwise activate the force generator 126, for example, in response to one or more combustion chamber conditions or engine parameters. When the force generator 126 actuates the driver 120, the driver 120 engages one or more stops 130 integrally formed with or otherwise attached to the first end portion of the valve 118 to move the valve 118 between the open and closed positions. The valve operator assembly 125 can also include a first biasing member 132 that contacts the valve 118 and at least partially urges the valve 118 to the closed position in a direction toward the nozzle portion 108. The valve operator assembly 125 can further include a second biasing member 135 that at least partially urges the driver 120 toward the nozzle portion 108. In certain embodiments, the first biasing member 132 can be a spring, such as a coil spring, and the second biasing member 135 can be a magnet or a permanent magnet. In other embodiments, however, the first biasing member 132 and the second biasing member 135 can include other components suitable for providing a biasing force against the valve 118 and the driver 120. Embodiments including a magnet or permanent magnet for the second biasing member can provide for relatively fast or quick actuation while inducing or avoiding potential resonance associated with coil springs.

In operation, the injector 100 is configured to inject two or more fuels, coolants, and/or combinations of fuels and coolants into the combustion chamber 112. The injector 100 is also configured to ignite the fuels as the fuels exit the nozzle portion 108 into the combustion chamber. For example, a first fuel or coolant can be introduced into the first flow passage 124 in the ignition conductor 116 via the first inlet passage 123 in the first terminal 127. Precise amounts of fuel and/or coolant can be metered from a pressurized fuel source from a valve assembly as described in detail below. The first fuel or coolant travels through the injector 100 from the base portion 106 to the nozzle portion 108. In instances where the nozzle portion 108 dispenses metered amounts of a pressurized first fuel, the first ignition source conductor 129 can energize or otherwise transmit ignition energy (e.g., voltage) to an ignition feature carried by the ignition conductor 116 at the nozzle portion 108. As such, the ignition conductor 116 can ignite the first fuel at the interface 111 with the combustion chamber 112.

A second fuel or coolant can be introduced into the base portion 106 via the force generator assembly 128. For example, a second fuel or coolant can enter the force generator assembly 128 via the second inlet passage 151b. The second fuel or coolant can travel from the second inlet passage 151 through the force generator 128 as indicated by base portion flow paths 139. The second fuel or coolant exits the force generator 128 through multiple exit channels 140 and then passes through passages 157 in the driver 120 to reach the second flow channel 133 extending longitudinally adjacent to the valve 118. As noted above, the second flow channel 133 extends between an outer surface of the valve 118 and an inner surface of the body insulator 142 of the middle portion 104 and the nozzle portion 108. The body insulator 142 can be made from a ceramic or polymer insulator suitable for containing the high voltage developed in the injector 100, as disclosed in the patent applications incorporated by reference in their entireties above.

The valve operator assembly 125 and the force generator assembly 128 work in combination to precisely and/or adaptively meter or dispense the second fuel or coolant into the second flow channel 133 and past the sealing head 119 of the valve 118. For example, the force generator 126 induces movement of the driver 120 to move the valve 118 longitudinally along the core insulator 116 to space the sealing end portion 119 of the valve 118 away from the valve seal 121. More specifically, when the force generator 126 induces the movement of the driver 120, the driver 120 moves a first distance D₁ prior to contacting the stop 130 carried by the valve 118. As such, the driver 120 can gain momentum or kinetic energy before engaging the valve 118. After the driver 120 contacts the stop 130, the driver 120 continues to move to a second or total distance D₂ while engaging the valve 118 to exert a tensile force on the valve 118 and move the valve 118 to the open position. As such, when the valve 118 is in the open position, the sealing head 119 of the valve 118 is spaced apart from the valve seal 121 by an open distance generally equal to the second or total distance D₂ minus the first distance D₁. As the valve 118 moves between the open and closed positions in directions generally parallel with a longitudinal axis of the injector 100, the ignition conductor 114 and the insulator 116 remain stationary within the body 102. The insulator 116 therefore acts as a central journal bearing for the valve 118 and can accordingly have a low friction outer surface that contacts the valve 118. Moreover, and as discussed in detail below, the second ignition feature 150 can create an ignition event to ignite the second fuel before or as the second fuel enters the combustion chamber 112.

As the second fuel flows toward the combustion chamber 112 through the second flow channel 133, the second ignition conductor 150 conveys DC and/or AC voltage to adequately heat and/or ionize and rapidly propagate and thrust the fuel toward the combustion chamber. In certain embodiments, the force generator assembly 128 can provide the ignition energy to the second ignition feature 150 via the second ignition conductor 154. For example, in embodiments where the force generator assembly 128 includes a primary solenoid winding or piezoelectric component that induces movement of the driver 120 and also induces voltage in a secondary solenoid winding, the secondary solenoid winding can provide the ignition energy to the second ignition feature. In other embodiments, however, the second terminal 152 can provide the ignition energy to the second ignition feature 150 via the second ignition conductor 154.

With respect to the first ignition features at the end portion 115 of the ignition conductor 114, as well as the second ignition feature 150, each ignition feature can develop plasma discharge blasts of ionized fuel that is rapidly accelerated and injected into the combustion chamber 112. Generating such high voltage at the ignition features initiates ionization, which is then rapidly propagated as a much larger population of ions in plasma that develops and travels outwardly to thrust fuel past the interface 111 into the combustion chamber 112 into surplus air to provide insulation of more or less adiabatic stratified chamber combustion. As such, the injector 100 is capable of ionizing air within the nozzle portion 108 prior to introducing fuel into the ionized air, ionizing fuel combined with air, as well as layers of ionized air without fuel and ionized fuel and air combinations, as disclosed in the patent applications incorporated by reference in their entireties above.

In one mode of operation, delivery of a rapid combustant such as hydrogen or hydrogen-characterized fuel mixture is made through inlet port 151 and past valve seal 119 to be ignited with relatively low ignition energy by electrode 150. Such rapid combustion as depicted by distribution pattern 160 thereby rapidly heats and forces rapid evaporation, cracking and completion of combustion of other fuels such as liquid diesel fuel that can be delivered through the second inlet port 123 and through conduit 124 to produce a second distribution pattern 162. The second distribution pattern 162 can be different than the first distribution pattern 160. This mode of rapid-combustant characterized operation enables other commensurately delivered fuels with relatively difficult ignition characteristics and/or tendencies to produce unburned hydrocarbon and/or particulate emissions including diesel and bunker fuels to be readily combusted without such emissions including applications in engines with insufficient compression ratios, fuel pressure, or operating temperature to provide satisfactory compression ignition.

In another mode of operation, fuel selections such as diesel and bunker fuels that normally produce such objectionable emissions are delivered through the second inlet 123 to conduit 124 for injection that is characterized by ionization by heat and/or plasma formation as a result of sufficiently greater ignition energy delivery through electrical lead 129 to force rapid evaporation, cracking and completion of combustion without such emissions. Application of such ignition energy enables clean utilization of fuels with insufficient cetane ratings for compression ignition and applications in engines with insufficient compression ratios, fuel pressure, or operating temperature to provide satisfactory compression ignition.

FIG. 1B is a cross-sectional end view of an embodiment of a second injector 100b taken substantially along lines 1B-1B in FIG. 1A. More specifically, the embodiment shown in FIG. 1A illustrates the concentric or coaxial arrangement of several of the components of the injector 100. However, for clarity the tubular cross section of valve 118 is not illustrated in FIG. 1B. In the illustrated embodiment, the second injector 100b includes a casing 159, such as a metallic or steel casing disposed over the body insulator 142. The second flow channel 133 is positioned radially outwardly from the valve and second ignition conductor 154, and the ignition insulator 116 is positioned radially inwardly from the valve and second ignition conductor 154. The fiber optic cables 117 are adjacent to the ignition conductor, and the first flow channel 124 extends through the ignition conductor. In the illustrated embodiment, the second flow channel 133 has a generally circular cross-sectional shape. In other embodiments, and as described below, the second flow channel 133 can include shapes other than circular and/or includes multiple sub-channels or discrete separated sub-portions for flowing various different fuels and/or coolants.

FIG. 1C is a cross-sectional end view of a third injector 100c taken substantially along lines 1B-1B in FIG. 1A. The embodiment of the third injector 100c shown in FIG. 1C illustrates several second flow sub-channels 133 (identified individually as first through nth sub-channels 133a-133n) between the body insulator 142 and the combination of the second ignition conductor 154 and second valve 118 (for clarity, the tubular cross-section of valve 118 is not illustrated in FIG. 1C). Although the illustrated embodiment includes second flow sub-channels 133 forming a star or gear shaped pattern, in other embodiments these flow channels can have other configurations. For example, FIG. 1D illustrates an additional embodiment of a fourth injector 100d having multiple discrete or separate second flow sub-channels 133 (identified individually as first through nth sub-channels 133a-133n) forming a generally pentagonal shape (for clarity, the tubular cross section of valve 118 is not illustrated in FIG. 1D). In other embodiments, however, the second flow sub-channels 133 can be arranged in other shapes or configurations.

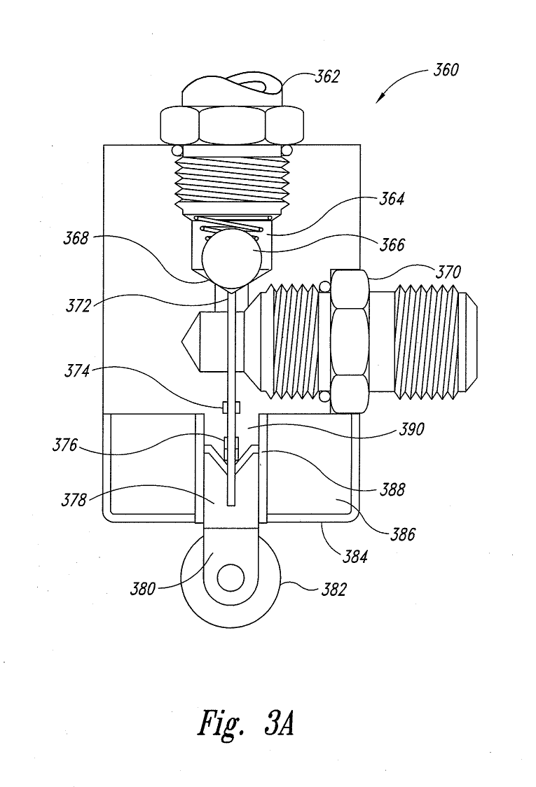

FIGS. 2A-2D are a series of cross-sectional side views of nozzle portions 214 of injectors configured in accordance with embodiments of the disclosure. The embodiments illustrated in FIGS. 2A-2D are configured to provide various spray patterns or distributions of fuels and/or coolants. For example, these embodiments provide examples of spray or distribution patterns that can be used to optimize combustion chamber conditions, such as temperature, pressure, completion of the combustion event, etc. In FIG. 2A, for example, a first nozzle portion 214a includes a first end portion 215a that dispenses or disperses a first injection or distribution pattern 260a into a combustion chamber. More specifically, the first end portion 215a can have one or more openings that create the first distribution pattern 260a. The first distribution pattern 260a can have a generally uniform expanding shape (e.g., cone-shaped). In certain embodiments, the first injection pattern 260a is suitable for a symmetrical combustion chamber.

In FIG. 2B, a second nozzle portion 214b includes a radially expanding second sleeve valve 262b covering at least a portion of a second end portion 215b. The second sleeve valve 262b is configured to open, expand, slide, or otherwise actuate in response to pressurized fuel and/or in response to one or more actuating devices. In one embodiment, the second sleeve valve 262b at least partially covers one or more second exit openings 266b in the second end portion 215b. The second nozzle portion 214b also includes a second end stop or plug 264b at least partially blocking the flow of fuel or coolant out of the second end portion 215b. As such, the second exit openings 266b are configured to allow the fuel or coolant to exit the second end portion 215b in a second injection or distribution pattern 260b. The second distribution pattern 260b accordingly includes a central void generally surrounded by a radially expanding cone shape of injected fuel and/or coolant.

In FIG. 2C, a third nozzle portion 214c includes a radially expanding sleeve valve 262c covering at least a portion of a third end portion 215c. The third sleeve valve 262c is configured to open, slide, or otherwise expand or actuate in response to pressurized fuel and/or in response to one or more actuating devices. The third sleeve valve 262c at least partially covers one or more third exit openings 266c in the third end portion 215c. The third nozzle portion 214c also includes a third end stop or plug 264c at least partially blocking the flow of fuel or coolant out of the third end portion 215c. In the illustrated embodiment, however, the third plug 264c has a generally conical shape that is inserted into an expanded section of the third end portion 215c. As such, the third exit openings 266c are configured to allow the fuel or coolant to exit the third end portion 215c in a third injection or distribution pattern 260c. The third distribution pattern 260c accordingly includes a conically-shaped radially expanding central void generally surrounded by a corresponding radially expanding cone shape of injected fuel and/or coolant.

In FIG. 2D, a fourth nozzle portion 214d includes a radially expanding sleeve valve 262d covering at least a portion of a fourth end portion 215d. The fourth sleeve valve 262d is configured to open, slide, or otherwise expand or actuate in response to pressurized fuel and/or in response to one or more actuating devices. The fourth sleeve valve 262d at least partially covers one or more fourth exit openings 266d in the fourth end portion 215d. The fourth nozzle portion 214d also includes a fourth end stop or plug 264d at least partially blocking the flow of fuel or coolant out of the fourth end portion 215d. In the illustrated embodiment, however, the fourth plug 264d has a generally conical shape that is inserted into an expanded section of the fourth end portion 215d. As such, the fourth exit openings 266d are configured to allow the fuel or coolant to exit the fourth end portion 215d in a fourth injection or distribution pattern 260d. The fourth distribution pattern 260d accordingly includes a converging central void generally surrounded by a corresponding radially expanding cone shape of injected fuel and/or coolant.

The embodiments described above with reference to FIGS. 2A-2D can accordingly provide various fuel and/or coolant distribution patterns (e.g., focused patterns, evenly distributed patterns, etc.) suitable for various ignition and cooling needs. One of ordinary skill in the art will appreciate, however, that the embodiments described above with reference to FIGS. 2A-2D are not exhaustive of all of the different configurations for various fuel distribution patterns. For example, the size, shape, orientation, and/or distribution of the exit openings 266 in the corresponding second end portions 215 can provide desired distribution patterns. In certain embodiments, a single nozzle portion 214 can include exit openings 266 having different sizes, shapes, and/or orientations. Moreover, these individual exit openings 266 can provide an outlet for corresponding individual flow channels or passages. Accordingly, a first fuel or first coolant can be dispensed through a first flow channel and corresponding exit opening 266 to provide a first distribution or spray pattern in the combustion chamber. In addition, a second fuel or second coolant can be dispensed through a second flow channel and corresponding exit opening 266 to provide a second distribution or spray pattern in the combustion chamber that is different from the first distribution pattern. Additional fuels and/or coolants can be dispensed through corresponding additional flow channels and exit openings.

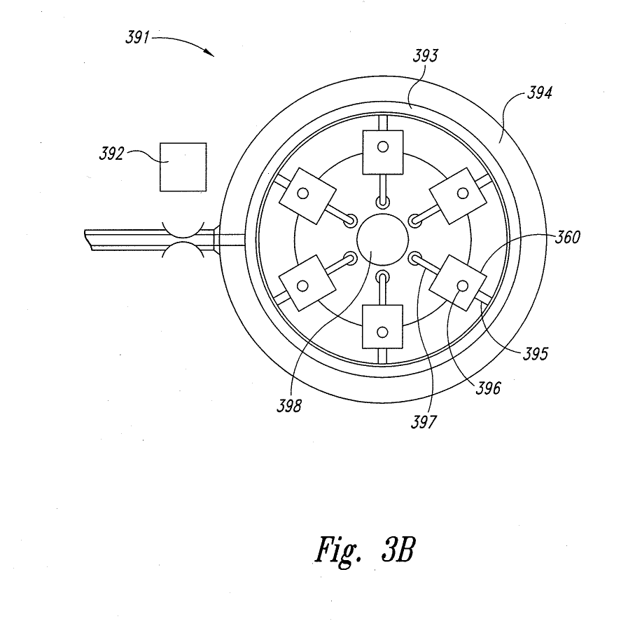

FIG. 3A is a cross-sectional side view of a valve distribution subassembly 360 (“subassembly 360”) that can be operably coupled to the first terminal 127 to deliver a first fuel or a first coolant to the injector 100 (as shown in FIG. 1A) from a pressurized fuel source. The subassembly 360 reliably enables control of the delivery of pressurized supplies of various fuels and/or coolants. According to aspects of this disclosure, the subassembly 360 is particularly beneficial for enabling various fuels including very low energy density fuels to be utilized in large engines in conjunction with an injector as described herein. The subassembly 360 also enables such fuels or coolants to be partially utilized to greatly improve the volumetric efficiency of converted engines by increasing the amount of air that is induced into the combustion chamber during each intake cycle. Although the subassembly 360 is described below in operation with reference to a fuel, in other application embodiments the subassembly 360 can dispense various coolants.

In operation, pressurized fluid such as a fuel is supplied through inlet fitting 362 to the valve chamber shown where a biasing member 364 (e.g., coil spring) urges a valve 366 (e.g., ball valve) toward a closed position on a valve seat 368 as shown in FIG. 3A. In high-speed engine applications, or where spring 364 is objectionable because solids in slush fuels tend to build up, it may be preferred to provide valve seat 368 as a pole of a permanent magnet to assist in rapid closure of the ball valve 366. When fuel delivery to a combustion chamber is desired, an actuator or push-rod 372 forces the ball valve 366 to lift off of the valve seat 368 to permit fuel to flow around the ball valve 366 and through the passageway to fitting 370 for delivery to the combustion chamber, such as through the first terminal 127 of the injector 100 (FIG. 1A). In certain embodiments, the push rod 372 can be sealed by closely fitting within a bore 390, or by an elastomeric seal such as an O-ring 374. The actuation of push rod 372 can be by any suitable method or combination of methods.

According to one embodiment, suitable control of fuel or coolant flow can be provided by solenoid action resulting from the passage of an electrical current through an annular winding 386 within a steel cap 384 in which a solenoid plunger 378 moves axially with connection to the push rod 372, as shown. In certain embodiments the plunger 378 can be made from a ferromagnetic material that is magnetically soft. Moreover, the plunger 378 can be guided in linear motion by a sleeve bearing 388, which can be a self-lubricating polymer, or low friction alloy, such as a Nitronic alloy, or a permanently lubricated powder-metallurgy oil-impregnated bearing that is threaded, engaged with an interference fit, locked in place with a suitable adhesive, swaged, or braised to be permanently located on the ferromagnetic pole piece 390.

In other embodiments, the ball valve 366 may also be opened by an impulse action in which the plunger 378 is allowed to gain considerable momentum before providing considerably higher opening force after it is allowed to move freely prior to suddenly causing actuator pin 372 to strike the ball valve 366. In this embodiment, it may be preferred to provide sufficient “at rest” clearance between the ball valve 366 and the end of the push rod 372 when the plunger 378 is in the neutral position at the start of acceleration towards the ball valve 366 to thereby allow considerable momentum to be developed before the push rod 372 suddenly impacts the ball valve 366.

As an alternative method for intermittent operation of the push rod 372 and the ball valve 366 can be with a rotary solenoid or mechanically driven cam displacement that operates at the same frequency that controls the air inlet valve(s) and/or the power stroke of the engine. Such mechanical actuation can be utilized as the sole source of displacement for ball valve 366 or in conjunction with a push-pull or rotary solenoid. In operation, for example, a clevis 380 holds a ball bearing assembly 382 in which a roller or the outer race of an antifriction bearing assembly rotates against or over a suitable cam to cause linear motion of the plunger 378 and the push rod 372 toward the ball valve 366. After striking the ball valve 366 for development of fuel flow as desired, the ball valve 366 and plunger 378 are returned to the neutral position by the magnetic seat 364 and/or a biasing member 376 (e.g., coil spring).

It is similarly contemplated that suitable operation of unit valve 360 may be by cam displacement of 382 with “hold-open” functions by a piezoelectric operated brake (not shown) or by actuation of electromagnet 386 that is applied to plunger 378 to continue the fuel or coolant flow period after passage of the cam lobe against 382. This provides fluid flow valve functions in which a moveable valve element such as 366 is displaced by plunger 372 that is forced by suitable mechanisms including a solenoid, a cam operator, and a combination of solenoid and cam operators in which the valve element 366 is occasionally held in position for allowing fluid flow by such solenoid, a piezoelectric brake, and/or a combination of solenoid and piezoelectric mechanisms.

Fuel and/or coolant flow from unit valve 360 may be delivered to the engine's intake valve port, to a suitable direct cylinder fuel injector, and/or delivered to an injector having selected combinations of the embodiments described herein. In some applications such as large displacement engines it is desirable to deliver fuel to all three entry points. In instances that pressurized fuel is delivered by timed injection to the inlet valve port of the combustion chamber during the time that the intake port or valve is open, increased air intake and volumetric efficiency is achieved by imparting fuel momentum to cause air-pumping for developing greater air density in the combustion chamber.

In such instances the fuel is delivered at a velocity that considerably exceeds the air velocity to thus induce acceleration of air into the combustion chamber. This advantage can be compounded by controlling the amount of fuel that enters the combustion chamber to be less than would initiate or sustain combustion by spark ignition. Such lean fuel-air mixtures however can readily be ignited by fuel injection and ignition by the injector embodiments described herein, which provides for assured ignition and rapid penetration by combusting fuel into the lean fuel-air mixture developed by timed port fuel injection.

Additional power may be provided by direct cylinder injection through a separate direct fuel injector that adds fuel to the combustion initiated by an injector such as the injector 100 described above with reference to FIG. 1A. Direct injection from one or more separate direct cylinder injectors into combustion initiated by the injector assures rapid and complete combustion within excess air and avoids the heat loss usually associated with separate direct injection and spark ignition components that require the fuel to swirl, ricocheting and/or rebounding from combustion chamber surfaces and then to combust on or near surfaces around the spark ignition source.

In larger engine applications, for high speed engine operation, and in instances that it is desired to minimize electrical current requirements and heat generation in solenoid 386 it is particularly desirable to combine mechanical cam actuated motion with solenoid operation of plunger assembly 378 and 372. This enables the primary motion of plunger 378 to be provided by a shaft cam. After the initial valve action of ball 366 is established by cam action for fuel delivery adequate for idle operation of the engine, increased fuel delivery and power production is provided by increasing the delivery pressure and/or “hold-on time” by continuing to hold plunger against stop 390 as a result of creating a relatively small current flow in annular solenoid winding 386. Thus, assured valve operation and precise control of increased power is provided by prolonging the hold-on time of plunger 378 by solenoid action following quick opening of ball 366 by cam action.

FIG. 3B is a plan partial view of a distribution assembly 391 configured in accordance with an embodiment of the disclosure. According to aspects of the disclosure, engines with multiple combustion chambers are provided with precisely timed delivery of fuel and/or coolant by the arrangement subassemblies 360 in the assembly 391 as shown in the schematic fuel control circuit layout of FIG. 3B. In this illustrative instance, six subassemblies 360 are located at equal angular spacing within a housing 394. The housing 394 provides conduits for pressurized fuel to each subassembly inlet 395 through a manifold 393. A cam on a rotating camshaft intermittently actuates corresponding push rod assemblies 397 to provide for precise flow of fuel from inlet 395 to a corresponding outlet 396, which in turn delivers to the fuel or coolant the desired intake valve port and/or combustion chamber directly or through the injector as shown in FIG. 1A. In certain embodiments, the housing 394 is preferably adaptively adjusted with respect to an angular position relative to the cam to provide spark and injection advance in response to adaptive optimization algorithms provided by a controller 392 as shown.

In certain embodiments, the controller 392 can provide adaptive optimization of each combustion chamber's fuel-delivery and spark-ignition events as a further improvement in efficiency, power production, operational smoothness, fail-safe provisions, and longevity of engine components. Moreover, the controller 392 can record sensor indications including the angular velocity of the cam to determine the time between each cylinder's torque development to derive positive and negative engine acceleration as a function of adaptive fuel-injection and spark-ignition data in order to determine adjustments needed for optimizing desired engine operation outcomes. For example, it is generally desired to produce the greatest torque with the least fuel consumption. However, in areas such as congested city streets where oxides of nitrogen emissions are objectionable, adaptive fuel injection and ignition timing provides maximum torque without allowing peak combustion temperatures to reach 2,200° C. (4,000° F.). This can be achieved by the disclosure of embodiments described in detail herein.

The fuels and/or coolants that are supplied to the injectors disclosed herein can be stored in any suitable corresponding storage containers. Moreover, these fuels or coolants can be pressurized to aid in the adaptive delivery of these fuels and/or coolants. In one embodiment, these fuels or coolants can be pressurized in the storage container without the use of a pump. For example, one or more chemical reactions can be controlled or otherwise allowed to occur to pressurize the corresponding fuels or coolants. More specifically, in certain embodiments, the storage container can be configured to store a pressurizing substance such as hydrogen, propane, or ammonia over diesel fuel. As such, in one embodiment the propane can be used as an expansive fluid by changing phase in response to energy that is added to the propane to produce propane vapor and consequently pressurize the diesel fuel storage vessel. In other embodiments, liquid hydrogen can be added to diesel fuel storage vessel. The liquid hydrogen can accordingly remove heat from the diesel fuel and pressurize the diesel fuel. Moreover, in still further embodiments ammonia or mothballs can be added to a fuel or coolant to accordingly dissociate and pressurize the fuel or coolant. Although several illustrative embodiments are disclosed above, one of ordinary skill in the art will appreciate that these are non-limiting embodiments and that various other processes and reactions including controlled gas releases from hydride or adsorptive media are suitable for pressurizing the fuel or coolant can be used.

According to additional features of the embodiments disclosed herein, injectors having the features described above can be used to inject and ignite fuels at relatively low pressures. For example, in one embodiment, such injectors can be used for operating conditions that do not exceed approximately 10 to 15 atmospheres (150 to 300 psi) over the max compression pressure of the engine. In other embodiments, however, these injectors can be used for operating conditions that are less than or that exceed approximately 150 to 300 psi over the max compression pressure of the engine. Accordingly, these injectors provide positive ignition and can be adaptively used for fuels that do not have a cetane rating requirement for the fuels.

According to yet additional features of the embodiments described above, the injectors are particularly suited to adaptively control the injection and ignition of various fuels and/or coolants. For example, the separate and electrically isolated first and second flow passages allow for different fuels to be injected and ignited. Moreover, these passages can produce different distribution or spray patterns of the fuels or coolants in the combustion chamber. What's more, the multiple discrete channels in the second flow passage can provide further adaptability or variation for the delivery, distribution, and/or ignition of various fuels and coolants. Injectors configured in accordance with embodiments of the disclosure can further be configured to adaptively adjust fuel/coolant delivery and/or ignition based at least upon the valve assembly operation, ignition energy transfer and/or operation, the type of fuel or coolant injected, as well as the pressure or temperature of the fuel or coolant that is injected.

In certain embodiment, an injector configured in accordance with an embodiment of the disclosure includes an injector body having a base portion configured to receive a first fuel and at least one of a second fuel and a coolant into the body, and a nozzle portion coupled to the base portion. The nozzle portion is configured to be positioned proximate to a combustion chamber for injecting the first fuel and at least one of the second fuel and the coolant into the combustion chamber. The injector can also include a valve seal positioned at or proximate to the nozzle portion, an ignition rod extending from the base portion to the nozzle portion, and a valve coaxially disposed over at least a portion of the ignition rod. The valve includes a sealing head that moves between an open position in which the sealing head is spaced apart from the valve seal, and a closed position in which the sealing head at least partially contacts the valve seal. The injector further includes a first flow channel extending longitudinally through a center portion of the ignition rod, and a second flow channel fluidly separated from the first flow channel and extending longitudinally through the body adjacent to the valve. The first flow channel is configured to deliver the first fuel to the nozzle portion, and the second flow channel is configured to deliver at least one of the second fuel and the coolant to the nozzle portion. The Injector further includes a first coupling fluidly coupled to the first flow channel to deliver the first fuel to the first flow channel, and a second coupling fluidly coupled to the second flow channel to deliver at least one of the second fuel and the coolant to the second flow channel.

According to certain embodiments of this injector the first ignition energy is greater than the second ignition energy, the ignition feature is concentric with the ignition rod. Moreover, the injector can also include a pressurized fuel source operably coupled to the injector body, wherein the pressurized fuel source stores the first fuel above an ambient pressure. The pressurized fuel source can at least partially pressurize the first fuel without the aid of a pump, and the pressurized fuel source can comprise a storage container that stores the first fuel, and wherein the storage container contains a chemical reaction that at least partially pressurizes the first fuel. The injector can also include a capacitor carried by the injector body and configured to store ignition energy to ignite at least one of the first fuel and the second fuel, wherein the ignition energy is harvested from the combustion chamber. The injector can further include a third coupling fluidly coupled to the third flow channel to deliver at least one of the third fuel and the second coolant to the third flow channel, as well as an ignition energy conductor operably coupled to the ignition conductor via the first fuel inlet, as well as an ignition energy source carried by the body. In certain embodiments, the first ignition energy is greater than the second ignition energy.

A method of operating a fuel injector in accordance with embodiments of the disclosure includes introducing a first fuel into a first flow channel in a body of the injector, dispensing the first fuel from first flow channel into a combustion chamber, activating a first ignition feature to at least partially ignite the first fuel, introducing at least one of a second fuel and a coolant into a second flow channel in the body, wherein the second flow channel is fluidly separated from the first flow channel, and actuating a valve to dispense at least one of the second fuel and the coolant from the second flow channel into the combustion chamber. The method can also include activating a second ignition feature to at least partially ignite the second fuel after the valve dispenses the second fuel. The first flow channel can be electrically isolated from the second flow channel, and wherein activating the first ignition feature includes applying a first voltage to the ignition feature, and activating the second ignition feature includes activating a second voltage to the second ignition feature, the second voltage being less than the first voltage. Moreover, actuating the valve comprises energizing a solenoid winding to induce movement of the valve from a closed position to an open position. In addition, the solenoid winding is a first solenoid winding and wherein the method can further comprise inducing a voltage in a second solenoid winding proximate to the first solenoid winding, and transmitting the voltage to the second ignition feature. Moreover, actuating the valve to dispense at least one of the second fuel and the coolant comprises actuating the valve in response to a change in at least one operating condition. Furthermore, the operating condition comprises at least one of the following: an increased power requirement, a decreased power requirement, a combustion chamber temperature, a combustion chamber pressure, a combustion chamber light value, and a combustion chamber acoustical value. The method can also include adaptively controlling at least one of dispensing the first fuel and actuating the valve to dispense at least one of the second fuel and the coolant based on one or more detected combustion chamber properties. In addition, actuating the valve comprises actuating the valve to dispense the coolant in response to a predetermined temperature in the combustion chamber, and dispensing the first fuel from first flow channel into the combustion chamber comprises dispensing a first non-cetane rated fuel from first flow channel into the combustion chamber.

The present application incorporates by reference in its entirety the subject matter of the following applications: U.S. Provisional Application No. 61/237,466, filed Aug. 27, 2009 and titled “MULTIFUEL MULTIBURST”; U.S. Provisional Patent Application No. 61/407,437, filed Oct. 27, 2010 and titled “FUEL INJECTOR SUITABLE FOR INJECTING A PLURALITY OF DIFFERENT FUELS INTO A COMBUSTION”; U.S. Provisional Application No. 61/304,403, filed Feb. 13, 2010 and titled “FULL SPECTRUM ENERGY AND RESOURCE INDEPENDENCE”; U.S. Provisional Application No. 61/312,100, filed Mar. 9, 2010 and titled “SYSTEM AND METHOD FOR PROVIDING HIGH VOLTAGE RF SHIELDING, FOR EXAMPLE, FOR USE WITH A FUEL INJECTOR”; U.S. Provisional Application No. 61/237,425, filed Aug. 27, 2009 and titled “OXYGENATED FUEL PRODUCTION”; U.S. Provisional Application No. 61/237,479, filed Aug. 27, 2009 and titled “FULL SPECTRUM ENERGY”; U.S. patent application Ser. No. 12/841,170, filed Jul. 21, 2010 and titled “INTEGRATED FUEL INJECTORS AND IGNITERS AND ASSOCIATED METHODS OF USE AND MANUFACTURE”; U.S. patent application Ser. No. 12/804,510, filed Jul. 21, 2010 and titled “FUEL INJECTOR ACTUATOR ASSEMBLIES AND ASSOCIATED METHODS OF USE AND MANUFACTURE”; U.S. patent application Ser. No. 12/841,146, filed Jul. 21, 2010 and titled “INTEGRATED FUEL INJECTOR IGNITERS WITH CONDUCTIVE CABLE ASSEMBLIES”; U.S. patent application Ser. No. 12/841,149, filed Jul. 21, 2010 and titled “SHAPING A FUEL CHARGE IN A COMBUSTION CHAMBER WITH MULTIPLE DRIVERS AND/OR IONIZATION CONTROL”; U.S. patent application Ser. No. 12/841,135, filed Jul. 21, 2010 and titled “CERAMIC INSULATOR AND METHODS OF USE AND MANUFACTURE THEREOF”; U.S. patent application Ser. No. 12/804,509, filed Jul. 21, 2010 and titled “METHOD AND SYSTEM OF THERMOCHEMICAL REGENERATION TO PROVIDE OXYGENATED FUEL, FOR EXAMPLE, WITH FUEL-COOLED FUEL INJECTORS”; U.S. patent application Ser. No. 12/804,508, filed Jul. 21, 2010 and titled “METHODS AND SYSTEMS FOR REDUCING THE FORMATION OF OXIDES OF NITROGEN DURING COMBUSTION IN ENGINES”; U.S. patent application Ser. No. 12/581,825, filed Oct. 19, 2009 and titled “MULTIFUEL STORAGE, METERING AND IGNITION SYSTEM”; U.S. patent application Ser. No. 12/653,085, filed Dec. 7, 2009 and titled “INTEGRATED FUEL INJECTORS AND IGNITERS AND ASSOCIATED METHODS OF USE AND MANUFACTURE”; U.S. patent application Ser. No. 12/006,774, filed Jan. 7, 2008 (now U.S. Pat. No. 7,628,137) and titled “MULTIFUEL STORAGE, METERING AND IGNITION SYSTEM”; U.S. patent application Ser. No. 12/913,749, filed Oct. 27, 2010 and titled “ADAPTIVE CONTROL SYSTEM FOR FUEL INJECTORS AND IGNITERS”; PCT Application No. PCT/US09/67044, filed Dec. 7, 2009 and titled “INTEGRATED FUEL INJECTORS AND IGNITERS AND ASSOCIATED METHODS OF USE AND MANUFACTURE”; and U.S. patent application Ser. No. 12/961,453, filed Dec. 6, 2010 and titled “INTEGRATED FUEL INJECTOR IGNITERS HAVING FORCE GENERATING ASSEMBLIES FOR INJECTING AND IGNITING FUEL AND ASSOCIATED METHODS OF USE AND MANUFACTURE”.

From the foregoing, it will be appreciated that specific embodiments of the disclosure have been described herein for purposes of illustration, but that various modifications may be made without deviating from the spirit and scope of the invention. For example, the dielectric strength of the insulators disclosed herein may be altered or varied to include alternative materials and processing means. The actuators and drivers may be varied depending on fuel and/or the use of the corresponding injectors. Moreover, components of the injector may be varied including for example, the electrodes, the optics, the actuators, the valves, and the nozzles or the bodies may be made from alternative materials or may include alternative configurations than those shown and described and still be within the spirit of the disclosure.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number, respectively. When the claims use the word “or” in reference to a list of two or more items, that word covers all of the following interpretations of the word: any of the items in the list, all of the items in the list, and any combination of the items in the list. In addition, the various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the disclosure can be modified, if necessary, to employ fuel injectors and ignition devices with various configurations, and concepts of the various patents, applications, and publications to provide yet further embodiments of the disclosure.

These and other changes can be made to the disclosure in light of the above-detailed description. In general, in the following claims, the terms used should not be construed to limit the disclosure to the specific embodiments disclosed in the specification and the claims, but should be construed to include all systems and methods that operate in accordance with the claims. Accordingly, the invention is not limited by the disclosure, but instead its scope is to be determined broadly by the following claims.

1. An injector comprising:
an injector body including—
a base portion configured to receive a first fuel and at least one of a second fuel and a coolant into the body; and
a nozzle portion coupled to the base portion, wherein the nozzle portion is configured to be positioned proximate to a combustion chamber for injecting the first fuel and at least one of the second fuel and the coolant into the combustion chamber;
a valve seal positioned at or proximate to the nozzle portion;
an ignition rod extending from the base portion to the nozzle portion;
a valve coaxially disposed over at least a portion of the ignition rod, wherein the valve includes a sealing head and moves between an open position in which the sealing head is spaced apart from the valve seal, and a closed position in which the sealing head at least partially contacts the valve seal;
a first flow channel extending longitudinally through a center portion of the ignition rod, wherein the first flow channel is configured to deliver the first fuel to the nozzle portion;
a second flow channel fluidly separated from the first flow channel and extending longitudinally through the body adjacent to the valve, wherein the second flow channel is configured to deliver at least one of the second fuel and the coolant to the nozzle portion;
a first coupling fluidly coupled to the first flow channel to deliver the first fuel to the first flow channel; and
a second coupling fluidly coupled to the second flow channel to deliver at least one of the second fuel and the coolant to the second flow channel.

2. The injector of claim 1, further comprising an ignition feature proximate to the ignition rod at the nozzle portion, wherein second flow channel delivers at least one of the second fuel and the coolant past the second ignition feature.

3. The injector of claim 2 further comprising:
a first ignition energy source coupled to the ignition rod for supplying a first ignition energy to ignite the first fuel; and
a second ignition energy source coupled to the ignition feature for supplying a second ignition energy to ignite the second fuel.

4. The injector of claim 1 wherein the nozzle portion injects the first fuel in a first injection pattern into the combustion chamber, and the nozzle portion injects at least one of the second fuel and the coolant in a second injection pattern into the combustion chamber, and wherein the first injection pattern is different than the second injection pattern.

5. The injector of claim 1, further comprising a force generator assembly that one of fuels flows through force generator assembly that moves the valve between the open and closed positions, and wherein the second flow channel extends through at least a portion of the force generator assembly.

6. The injector of claim 1 wherein the valve moves longitudinally through the injector body as the valve moves between the open and closed positions to dispense at least one of the second fuel and the coolant from the second flow channel into the combustion chamber.

7. The injector of claim 1, further comprising a third flow channel fluidly separate from the first flow channel and the second flow channel, and wherein the third flow channels is configured to deliver at least one of a third fuel and a second coolant to the nozzle portion.

8. An injector comprising:
a body having a first end portion and a second end portion;
a first flow channel extending through the body, wherein the first flow channel receives a first fuel;
a second flow channel extending through the body, wherein the second flow channel is separate from the first flow channel and electrically isolated from the first flow channel, wherein the second flow channel receives at least one of a second fuel and a coolant; and
a valve carried by the body, wherein the valve is movable between a closed position and an open position to introduce at least one of the second fuel and the coolant into a combustion chamber.

9. The injector of claim 8, further comprising an ignition conductor extending longitudinally through at least a portion of the body, wherein the first flow channel extends longitudinally through a central portion of the ignition conductor.

10. The injector of claim 8, further comprising:
a first fuel inlet operably coupled to the first fuel flow channel; and
a second fuel inlet operably coupled to the second fuel flow channel.

11. The injector of claim 8, further comprising a pressurized fuel source that stores the first fuel, wherein the first fuel is selectively introduced into the first fuel flow channel from the pressurized fuel source to introduce the first fuel into the combustion chamber.

12. The injector of claim 8 wherein the ignition conductor is a first ignition conductor, and wherein the injector further comprises a second ignition conductor at the second end portion of the body, wherein the first ignition conductor ignites the first fuel and the second ignition conductor ignites the second fuel.

13. The injector of claim 12, further comprising:
a first ignition source coupled to the first ignition conductor to supply a first ignition energy; and
a second ignition source coupled to the second ignition conductor to supply a second ignition energy.

14. A method of adaptively operating a fuel injector, the method comprising:
introducing at least one of a first fuel and a first coolant into a first flow channel in a body of the injector;
dispensing at least one of the first fuel and the first coolant from first flow channel into a combustion chamber in a first distribution pattern;
introducing at least one of a second fuel and a coolant into a second flow channel in the body, wherein the second flow channel is fluidly separated from the first flow channel;
dispensing at least one of the second fuel and the second coolant from the second flow channel into the combustion chamber in a second distribution pattern, wherein the second distribution pattern is different from the first distribution pattern; and
when dispensing at least one of the first fuel and the second fuel, at least partially igniting the first fuel or the second fuel with an ignition feature carried by the body of the injector.

15. The method of claim 14, further comprising adaptively dispensing at least one of the first fuel, the second fuel, and the coolant in response to one or more combustion chamber properties.

16. (canceled)

17. The method of claim 16 wherein dispensing at least one of the third fuel and the third coolant from the third flow channel into the combustion chamber comprises dispensing at least one of the third fuel and the third coolant into the combustion chamber in the second distribution pattern.

18. The method of claim 16 wherein dispensing at least one of the third fuel and the third coolant from the third flow channel into the combustion chamber comprises dispensing at least one of the third fuel and the third coolant into the combustion chamber in a third distribution pattern, and wherein the third distribution pattern is different from the first and second distribution patterns.

19. The method of claim 14 wherein at least partially igniting the first fuel or the second fuel with an ignition feature carried by the body of the injector comprises at least partially igniting the first fuel with a first ignition feature and at least partially igniting the second fuel with a second ignition feature different from the first ignition feature.

20. The method of claim 19 wherein at least partially igniting the first fuel comprises applying a first ignition energy to the first ignition feature, and at least partially igniting the second fuel comprises applying a second ignition energy to the second ignition feature, wherein the second ignition energy is greater than or less than the first ignition energy.
